(19) United States
(12) Patent Application Publication
(10) Pub. No.: US 2026/0062827 A1
(43) Pub. Date: Mar. 5, 2026

(54) ELECTROLYTIC PROCESS FOR PRODUCING CEMENT

(71) Applicant: Blue Origin Manufacturing, LLC, Huntsville, AL (US)

(72) Inventor: Alex M. Román, Santa Monica, CA (US)

(21) Appl. No.: 18/816,351

(22) Filed: Aug. 27, 2024

(51) Int. Cl. C25C 3/02; C04B 7/32; C25C 3/06

(52) U.S. Cl. CPC C25C 3/02; C04B 7/32; C25C 3/06

(57) ABSTRACT

A method and system for producing cement using electrolysis is presented. Via an electric current, an electrolysis process may be performed on a melted oxide material, which may be anorthosite. Calcium oxide may be collected from the electrolysis process and mixed with silica and alumina to produce cement.

### BACKGROUND

Lunar regolith contains minerals primarily comprising elements such as silicon, titanium, aluminum, magnesium, iron, and calcium, which are typically measured and expressed in their oxide form. Molten oxide electrolysis (MOE) is being pursued as an alternative for existing metal production technologies as well as for in situ oxygen and metal production on planetary bodies such as the Moon. MOE is a process that may be used to reduce molten oxides to their metal form using an electric current. For example, MOE may be used as an electrometallurgical technique to produce iron metal in a liquid state from oxide feedstock.

On Earth, the relatively low cost and widespread availability of limestone, shales, and other naturally occurring materials used in a process to produce portland cement make it a relatively inexpensive building material. Its most common use is in the production of concrete, which is a composite material that includes aggregate (gravel and sand), cement, and water. Unfortunately, the process has been estimated to contribute up to 10% of Earth's greenhouse gas emissions, mostly in the form of CO₂. Much of these emissions is derived from fuel needed to heat ingredients of the cement-making process. For example, the basic manufacturing process heats the ingredients in a kiln to about 1400 to 1600° C. (2600-3000° F.), which is a temperature range in which the ingredients interact chemically to form calcium silicates. This heated substance, called “clinker” is usually in the form of small gray-black pellets about 12.5 mm (0.5 inches) in diameter. Clinker is then cooled and pulverized into a fine powder that almost completely passes through a 0.075 mm (No. 200) sieve and may be fortified with a small amount of gypsum. The result is portland cement.

Although there are a number of variations of commercially manufactured portland cement, they each share many of the same basic raw materials and chemical components. The chief chemical components of portland cement are calcium, silica, alumina, and iron. On Earth, calcium may be derived from limestone, marl or chalk, for example, while silica, alumina, and iron may come from sands, clays, and iron ore sources. Other raw materials may include shale, shells, and industrial byproducts such as mill scale.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic representation of an electrolysis process for producing cement, according to some embodiments.

FIG. 2 is a schematic cross-section of a system for molten oxide electrolysis (MOE), according to some embodiments.

FIG. 3 is a flow diagram of a process for producing cement, according to some embodiments.

### DETAILED DESCRIPTION

This disclosure describes, among other things, a system and a method for producing cement using an electrolysis process. The cement may be the same as or similar to portland cement, which is generally in a powdered form. Subsequent to the addition of water and possibly aggregate, the cement may form concrete.

Anorthosite is a raw material that includes a number of components that are used to make cement. For example, portland cement generally comprises silica, calcium oxide, alumina, magnesia, and iron oxide. Anorthosite's chemical formula is CaO·Al₂O₃·2SiO₂, which is one calcium oxide, one alumina (aluminum oxide), and two silicas (silicon oxide). An electrolysis process may be used to separate the calcium oxide from the alumina and silica, which together are called aluminum silicate (e.g., xAl₂O₃·ySiO₂, where x and y are integers). Thus, in some embodiments, a method for making cement includes electrolyzing melted anorthosite to produce oxygen at an anode of an electrolysis cell and aluminum silicate at a cathode of the electrolysis cell. Remaining calcium oxide may be removed and collected from the electrolysis cell. The method may include cooling, mixing together, and pulverizing the aluminum silicate and the calcium oxide to produce a hydrophilic cement powder.

Oxide material may be derived from lunar regolith. For example, iron oxide may be in lunar regolith or in minerals found on off-Earth locations and/or objects in the Solar System, such as asteroids, moons, minor-planets, and planets, among other objects. Of course, iron oxide is also present on Earth, and methods described herein may be performed on Earth, the moon, or other bodies listed above, and claimed subject matter is not limited in this respect. In some embodiments, lunar regolith may be a raw material from which anorthosite may be derived using a molten oxide electrolysis (MOE) process. In these embodiments, the MOE process may produce an iron-depleted melt that may be the same as or similar to anorthosite. Subsequent to MOE, a second electrolysis process may be used, as described above, to derive aluminum silicate and calcium oxide from the iron-depleted melt.

In various embodiments, a method for producing cement using electrolysis includes using an electric current to perform electrolysis in a vessel containing a melted oxide material, collecting calcium oxide from the electrolysis, and mixing the calcium oxide with silica and alumina to produce the cement. In some implementations, the oxide material may be anorthosite, wherein the electrolysis separates the anorthosite into oxygen, aluminum silicate, and the calcium oxide. The method may also include separately collecting the oxygen, the aluminum silicate, and the calcium oxide into respective containers for use at a later time, for example. The aluminum silicate generally comprises silica and alumina.

Subsequent mixing of the calcium oxide with the silica and the alumina may involve measuring a quantity of the calcium oxide with respect to quantities of the silica and the alumina and mixing together particular portions of each of the calcium oxide, the silica, and the alumina to produce the cement.

The anorthosite may be derived from lunar regolith or ore (e.g., ore from the Earth). In some implementations, before performing the electrolysis process, the lunar regolith or ore may be beneficiated to produce, or to increase a concentration of, anorthosite. For example, lunar regolith may be beneficiated to increase the concentration of anorthosite in regolith-based feedstock to over 80-90%.

In some embodiments, before performing the electrolysis process described above, an MOE process may be performed on melted lunar regolith to separate iron and oxygen from the melted lunar regolith. This process may produce an iron-depleted melt, which may be at least similar to anorthosite, that is then used for the subsequent electrolysis process. In some implementations, the iron and the oxygen derived from the MOE process may be used to produce iron oxide, which may be combined with the calcium oxide, the silica, and alumina to produce the cement.

In some implementations, the calcium oxide, the silica, and the alumina may be collected from one or more storage vessels, cooled, and pulverized to produce the cement as a powder. In some cases, impurities from the iron-depleted melt and/or in the vessel used in the electrolysis process may be collected and added to the cement to form a mixture of cement and aggregate. For example, such aggregate may range in size from small sand-like grains to larger pebble-like clusters. Interestingly, in other applications, raw materials, such as those on Earth or the Moon, may generally lead to materials with impurities that are undesired in subsequent steps of production or fabrication. In contrast, however, the cement produced in embodiments described herein may utilize the impurities. For example, oxides of iron and manganese, in relatively small quantities, can be beneficial to cement material properties. This includes CO2 uptake during the curing process of the final concrete product (allowing for carbon sequestration potential).

In some embodiments, a method for producing cement may include electrolyzing melted anorthosite in an electrolysis cell, collecting i) oxygen from an anode of the electrolysis cell, ii) aluminum silicate from a cathode of the electrolysis cell, and iii) calcium oxide from the electrolysis cell, and cooling, mixing together, and pulverizing the aluminum silicate and the calcium oxide to produce a hydrophilic cement powder. Electrolyzing the melted anorthosite may result in separation of the anorthosite into the oxygen, the aluminum silicate, and the calcium oxide. Before electrolyzing the melted anorthosite, in some implementations, lunar regolith may be beneficiated to produce the anorthosite. In some cases, the anorthosite may have a purity greater than about 90%.

In some implementations, melted lunar regolith may be
electrolyzed via MOE to at least partially remove iron and oxygen from the melted lunar regolith to produce an iron-depleted melt. The iron-depleted melt may comprise anorthosite. At a later time in the process, the iron may be combined with the oxygen from a storage vessel to produce iron oxide, which may be combined with calcium oxide and aluminum silicate. For example, iron and oxygen may be recombined to form the oxide (e.g., “rust”). The recombination reaction is exothermic and thermodynamically favorable. In one example process, a blast furnace may be used to ignite iron metal and utilize the heat generated in other parts of the process (either to provide heat to the process itself or to generate electricity). However, the iron could also be used in an iron-air battery as an energy storage medium and then “discharged” to form iron oxide and electricity. This latter process may be particularly useful if renewable electricity is less abundant (e.g., at night or during the winter in the case of solar energy generation).—Other source of iron oxide may be scrap metal or iron ore (e.g., any grade). The hydrophilic cement powder may be the same as or similar to portland cement, which includes calcium oxide, silica, alumina, magnesia, and iron oxide, for example.

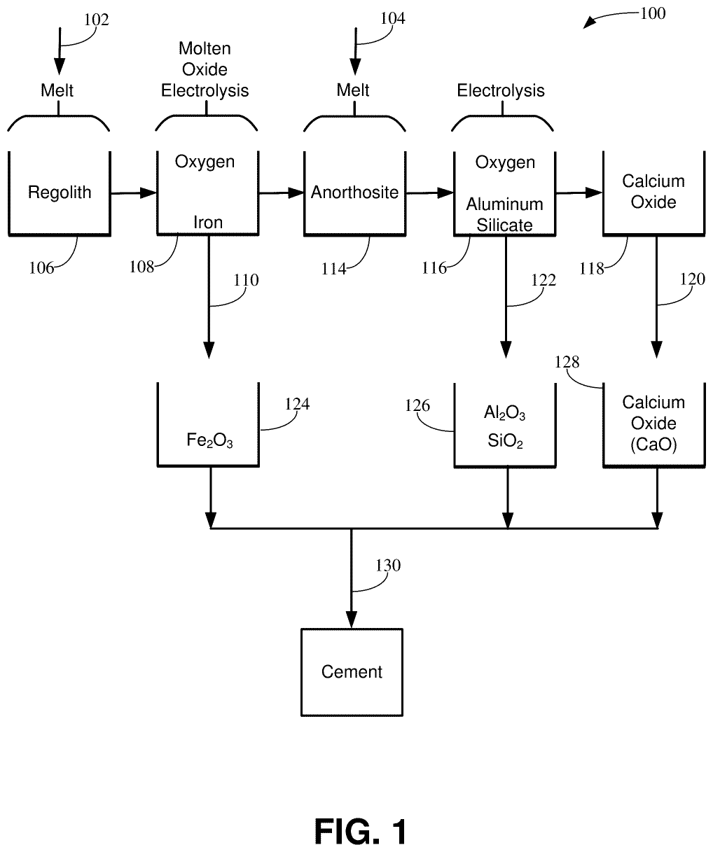

FIG. 1 is a schematic representation of an electrolysis process 100 for producing cement. In some embodiments, process 100 may begin at 102, wherein lunar regolith is used as a feedstock for the process. In other embodiments, process 100 may begin at 104, wherein anorthosite is used as a feedstock for the process. Lunar regolith may comprise SiO₂, Al₂O₃, MgO, FeO, and CaO, among other things. On the other hand, anorthosite generally comprises Ca, Al, Si, and O in the form of CaO+Al₂O₃+2SiO₂. Accordingly, the presence of iron in lunar regolith feedstock may be a main difference between starting at 102, wherein iron is to be removed, and 104, wherein iron is a priori absent, of process 100. Note that iron oxide is not necessary for the formation of the cement and its inclusion is more beneficial for terrestrial applications where it can react with atmospheric CO2 to form iron carbonate within the cement as the cement cures.

In embodiments for which process 100 begins at 102, regolith may be harvested and melted in a heating process at 106. In some cases the regolith may be carefully harvested so as to naturally include a substantial amount of anorthosite, which is generally an abundant mineral on earth and the Moon. Instead of, or in addition to, such careful harvesting, the regolith may be beneficiated to increase the concentration of anorthosite.

At 108, an MOE process is performed on the melted regolith to substantially remove iron and oxygen from the melt. Iron oxide is a major component of lunar regolith, particularly in the Mare regions of the moon. In solar panel fabrication implementations, the molten regolith electrolysis process generally requires the removal of iron oxide in order to produce sufficiently clear glass for the production of solar cells as well as to prevent iron contamination in the silicon metal that is needed to produce the solar cells. During the MOE process, the iron may accumulate as a cathode at or near the bottom of a vessel containing the melt. As indicated by arrow 110, the iron may be removed from the vessel and stored for later use or may be combined with oxygen to form iron oxide and then stored for later use. The oxygen, which is separated from the melt and collected at an anode near the top of the melt, may be collected and stored for later use. As a consequence of the MOE process, the melt is iron-depleted. In other words, the melt is essentially lunar regolith with substantially less iron oxide. In some implementations, the iron-depleted melt may be cooled, solidified, and stored as an anorthosite feedstock for later processing. In other implementations, the iron-depleted melt may be maintained in a liquid state as melted anorthosite that is then processed in a subsequent step starting at 114 of process 100. At 116, the iron-depleted melt, which may be primarily anorthosite, is electrolyzed in an electrolytic cell to separate out from the melt aluminum silicate and calcium oxide. The electrolysis tends to precipitate the aluminum silicate on a cathode of the vessel while oxygen forms on a corresponding anode. After aluminum silicate is at least partially removed from the melt by electrolysis, a resulting slag (formed by the electrolysis) contains a substantial concentration of calcium oxide. At 118, the calcium oxide may be removed from the slag in the electrolytic cell. In some implementations, the calcium oxide may be cooled, pulverized, and stored for later use, as indicated by arrow 120. Also, the aluminum silicate may be removed from the electrolytic cell, as indicated by arrow 122, and stored for later use. The aluminum silicate need not be fully decomposed or separated to make the cement, but it may be desirable to adjust the ratio of alumina to silica, depending on the source. Given that cement is traditionally more enriched with alumina as compared to the case for natural regolith, the silica may be decomposed/removed in the molten regolith electrolysis process. The output electrolyte (e.g., primarily molten alumina, calcia, and silica) may then be the building blocks for the cement. The MOE process may be stopped at an appropriate time such as when the composition would be optimal for cement production. In some implementations, the decomposed products, including iron and silicon metal as well as oxygen gas, for example, may be used for other applications.

For producing cement, iron oxide 124, from the process step of 108, alumina and silica 126, from the process step of 116, and calcium oxide 128, from the process step of 118, may be combined together in measured proportions. These ingredients may be pulverized before or after their combining, as indicated by arrow 130.

In other embodiments wherein process 100 begins at 104 with anorthosite feedstock, the process is similar to that described above but instead starts at process step 114. One notable difference from the above process is that iron oxide added during the combining 130 need not be produced by MOE and may be provided by other sources, for example.

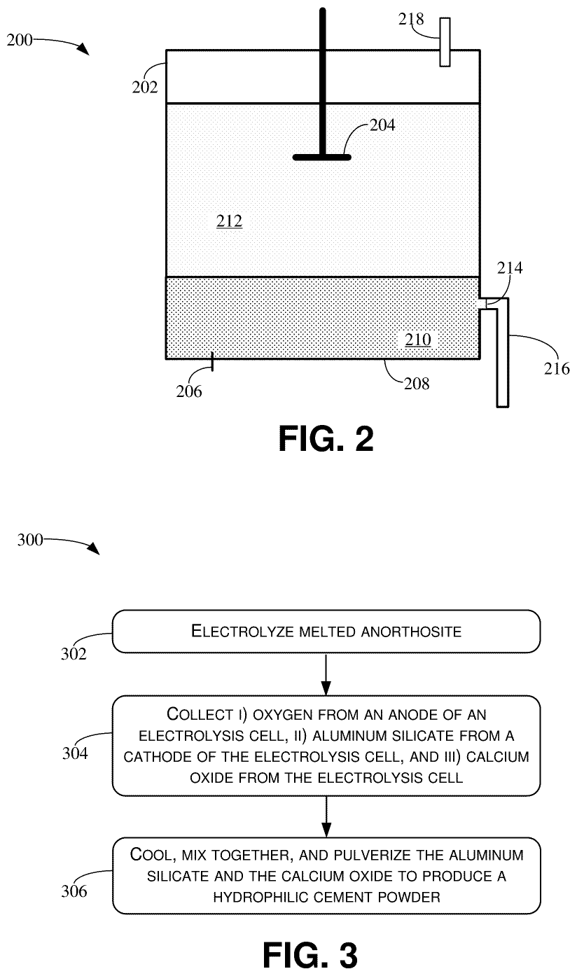

FIG. 2 is a schematic cross-section of an MOE system 200, according to some embodiments. MOE system 200 may be used in step 108 of process 100, for example. Various portions of the system, as illustrated, are not necessarily to scale. The MOE system generally comprises electrical and mechanical components that are interfaced with one another in various configurations. The MOE system may further comprise one or more computer processors configured to execute computer-readable instructions, which may be directed to controlling at least some of the electrical and mechanical components.

MOE system 200 may include a vessel 202 (e.g., an electrolysis vessel), an anode 204 protruding into the vessel from above, and a cathodic electrode 206, which may be located at or near the bottom 208 of the vessel. The cathodic electrode is configured to be in electrical contact with a lower portion of contents, such as a liquid cathode 210, contained in vessel 202. The anode and cathodic electrode may be part of a single electrical electrolysis circuit that includes a voltage or current source (not illustrated). Accordingly, a current may flow between the anode and cathodic electrode, creating a voltage difference across molten oxide material 212 that is between and surrounding the anode and cathodic electrode. As mentioned above, in some implementations, a generic composition of oxides, such as those derived from lunar regolith, may be SiO₂+Al₂O₃+MgO+FeO+CaO with trace alkali oxides and halides. The electrical current between the anode and cathodic electrode may allow for a process of electrolysis of oxide material 212. Distances between the anode and cathodic electrode may be varied to adjust voltage and/or current of the electrolysis circuit. Such variation may be useful to account for varying resistivity of molten oxide material 212 and liquid cathode 210, for example. The electrolysis of molten oxide material 212 may produce at least a portion of liquid cathode 210, which, in embodiments described herein, is iron that is denser than the surrounding molten oxide material. Accordingly, the liquid cathode (e.g., iron) will sink toward the bottom of vessel 202 and thus be in electrical contact with cathodic electrode 206. It is from this portion of vessel 202 that iron may be removed from the vessel and harvested. For example, in some implementations, MOE system 200 may further include a valve 214 and conduit 216 for removing molten oxide material 212 and/or liquid cathode 210 (e.g., iron). In some implementations, oxygen gas may be produced from the electrolysis process performed on vessel 202. The oxygen gas may be collected via an exit port 218. As described above, the iron and the oxygen may be used to, among other things, produce iron oxide (e.g., Fe₂O₃).

FIG. 3 is a flow diagram of a process 300 for producing cement, according to some embodiments. The process may be performed by an operator, which may be a person or persons, a computer processor executing computer-readable code, or a combination thereof. Process 300 may include at least a portion of electrolysis process 100, for example.

At 302, the operator may heat, melt, and electrolyze anorthosite in an electrolytic cell. Some methods of heating the anorthosite include induction heating and microwave heating using a susceptor material, just to name a few examples. Claimed subject matter is not limited to any particular method of heating. At 304, the operator may collect i) oxygen from an anode of an electrolysis cell, ii) aluminum silicate from a cathode of the electrolysis cell, and iii) calcium oxide from the electrolysis cell. At 306, the operator may cool, mix together, and pulverize the aluminum silicate and the calcium oxide to produce a hydrophilic cement powder. For example, the aluminum silicate, the calcium oxide, and oxygen may be separately collected into respective containers and quantities of each of these ingredients may be measured (e.g., the calcium oxide may be measured with respect to quantities of the silica and the alumina that compose the aluminum silicate). Accordingly, particular portions of each of the ingredients may be mixed together to produce the cement.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A method for producing cement using electrolysis, the method comprising:
via an electric current, performing an electrolysis process in a vessel containing a melted oxide material;
collecting calcium oxide resulting from the electrolysis process; and
mixing the calcium oxide with silica and alumina to produce the cement.

2. The method of claim 1, wherein the oxide material is anorthosite.

3. The method of claim 2, wherein the electrolysis process separates the anorthosite into oxygen, aluminum silicate, and the calcium oxide.

4. The method of claim 3, further comprising:
separately collecting the oxygen, the aluminum silicate, and the calcium oxide into respective containers, wherein the mixing of the calcium oxide with the silica and the alumina comprises:
measuring a quantity of the calcium oxide with respect to quantities of the silica and the alumina; and
mixing together particular portions of each of the calcium oxide, the silica, and the alumina to produce the cement.

5. The method of claim 2, further comprising:
before performing the electrolysis process, beneficiating lunar regolith or ore to produce the anorthosite.

6. The method of claim 1, further comprising:
before performing the electrolysis process, melting lunar regolith;
performing a molten oxide electrolysis (MOE) process on the melted lunar regolith to separate iron and oxygen from the melted lunar regolith to produce an iron-depleted melt;
separately collecting the iron, the oxygen, and the iron-depleted melt; and
placing the iron-depleted melt into the vessel for the electrolysis process.

7. The method of claim 6, wherein the iron-depleted melt comprises the anorthosite.

8. The method of claim 5, further comprising:
combining the iron with the oxygen to produce iron oxide; and
combining the iron oxide with the calcium oxide, the silica, and alumina to produce the cement.

9. The method of claim 1, further comprising:
removing the calcium oxide, the silica, and the alumina from the vessel;
cooling the calcium oxide, the silica, and the alumina; and
pulverizing the calcium oxide, the silica, and the alumina to produce the cement.

10. The method of claim 1, further comprising:
collecting impurities from the vessel; and
adding the impurities to the cement to form a mixture of cement and aggregate.

11. The method of claim 1, wherein the silica and alumina are in the form of aluminum silicate.

12. A method for producing cement, the method comprising:
electrolyzing melted anorthosite;
collecting i) oxygen from an anode of an electrolysis cell, ii) aluminum silicate from a cathode of the electrolysis cell, and iii) calcium oxide from the electrolysis cell; and
cooling, mixing together, and pulverizing the aluminum silicate and the calcium oxide to produce a hydrophilic cement powder.

13. The method of claim 12, wherein electrolyzing the melted anorthosite separates the anorthosite into the oxygen, the aluminum silicate, and the calcium oxide.

14. The method of claim 12, further comprising:
before electrolyzing the melted anorthosite, beneficiating lunar regolith to produce the anorthosite, wherein the anorthosite has a purity greater than about 80%.

15. The method of claim 12, further comprising:
before electrolyzing the melted anorthosite, melting lunar regolith;
performing molten oxide electrolysis (MOE) on the melted lunar regolith to at least partially remove iron and oxygen from the melted lunar regolith to produce an iron-depleted melt, wherein the iron-depleted melt comprises the anorthosite.

16. The method of claim 15, further comprising:
combining the iron with oxygen from a storage vessel to produce iron oxide; and
combing the iron oxide with the calcium oxide and the aluminum silicate, wherein the hydrophilic cement powder is a portland cement that includes the calcium oxide, silica, alumina, magnesia, and the iron oxide.

17. The method of claim 12, further comprising:
collecting impurities from the electrolysis cell; and
adding the impurities to the hydrophilic cement powder to form a mixture of cement and aggregate.

18. A method for producing cement, the method comprising:
melting lunar regolith;
performing molten oxide electrolysis (MOE) on the melted lunar regolith to at least partially remove iron from the melted lunar regolith and to produce an iron-depleted melt that comprises anorthosite;
electrolyzing the anorthosite to separate aluminum silicate and calcium oxide from the anorthosite; and
cooling, mixing together, and pulverizing the aluminum silicate and the calcium oxide to produce a cement powder.

19. The method of claim 18, further comprising:
before performing the MOE, beneficiating the lunar regolith to increase a concentration of the anorthosite in the lunar regolith.

20. The method of claim 18, further comprising:
collecting impurities from the iron-depleted melt; and
adding the impurities to the cement powder to form a mixture of cement and aggregate.
